(19) United States
(12) Patent Application Publication
(10) Pub. No.: US 2004/0267988 A1
(43) Pub. Date: Dec. 30, 2004

(54) Smart hard-disk drive

(76) Inventor: Guobiao Zhang, Stateline, NV (US)

Correspondence Address: Guobiao Zhang, P.O. Box 6182, Stateline, NV, 89449-6182, US

(21) Appl. No.: 10/902,646

(22) Filed: Jul. 28, 2004

Related U.S. Application Data
(63) Continuation-in-part of application No. 10/685,887, filed on Oct. 14, 2003.
(60) Provisional application No. 60/585,123, filed on Jul. 2, 2004.

(30) Foreign Application Priority Data
Oct. 22, 2002 (CN) 02133943.0
Dec. 13, 2003 (CN) 200310120998.0

(51) Int. Cl. G06F 13/00

(52) U.S. Cl. 710/74

(57) ABSTRACT

The present invention discloses a smart hardisk drive (sHDD). It can store data for and directly (i.e. without using a computer as an intermediary) communicate with at least two types of multimedia devices. A single sHDD can accommodate almost all on-the-go multimedia storage needs. With a large capacity, small size and reasonable price, the sHDD will become a universal multimedia storage platform.

This is a continuation-in-part of Application Sr. No. 10/685,887, filed on Oct. 14, 2003. It also claims priority on Chinese Patent Application Sr. No. 200310120998.0, filed on Dec. 13, 2003; Provisional Application Sr. No. 60/585,123, filed on Jul. 2, 2004.

### CROSS-REFERENCE TO RELATED APPLICATIONS

This patent application relates to the following domestic patent applications:

1. “Smart Hard-Disk Drive”, Provisional Application Sr. No. 60/433,235, filed on Dec. 13, 2002;

2. “Smart Hard-Disk Drive”, Provisional Application Sr. No. 60/436,292, filed on Dec. 24, 2002;

3. “Smart Hard-Disk Drive And Methods”, Provisional Application Sr. No. 60/585,123, filed on Jul. 2, 2004,

and the following foreign patent applications:

1. “Smart Hard-Disk Drive”, CHINA P. R, Application Sr. No. 02133943.0, filed on Oct. 22, 2002;

2. “Smart Hard-Disk Drive”, CHINA P. R., Application Sr. No. 200310120998.0, filed on Dec. 13, 2003,

all by the same inventor.

### BACKGROUND

1. Technical Field of the Invention

The present invention relates to the field of electronic storage systems, and more particularly to smart hard-disk drive (sHDD).

2. Prior Arts

Portable digital multimedia devices (hereinafter referred to as “multimedia devices”, “devices”) are portable devices that record and/or play multimedia (e.g. audio/video, i.e. AN) information. They can be categorized into digital recording device, digital playing device and digital multi-function device. Digital recording device (DR) comprises at least a recording means, which converts external analog multimedia signals into digital multimedia data and records these multimedia data onto a storage medium. Examples include digital still camera, digital camcorder, and digital voice recorder. Digital playing device (DP) comprises at least a playing means, which converts digital multimedia data into perceptible (analog) multimedia signals. Examples include digital audio player (e.g. MP3-player, CD player), digital movie player (e.g. VCD/DVD player, microdisplay-based video-player), portable game machine (e.g. GameBoy), and global positioning system (GPS). Digital multi-function devices comprise both recording and playing means. Examples include personal versatile recorder (PVR), camera (or video) phones with built-in MP3 player, and personal digital assistant (PDA).

Being descendents of analog multimedia devices, digital multimedia devices simply follow a legacy “bundled” storage model from analog era, i.e. each type of devices is “bundled” with a dedicated storage. For example, digital still camera uses removable flash cards (e.g. CF, MM, SD, MS, xD . . . ); digital camcorder uses videotapes (e.g. VHS, 8 mm, Hi₈, MiniDV, MicroMV . . . ) or DVD-R; digital audio player uses embedded flash or microdrive; digital movie player uses optical discs (e.g. VCD, DVD . . . ). Storage is hardly shared among devices and the multimedia storage standards are disordered. Table 1 lists the storage costs for a typical consumer. If a consumer owns several devices listed in Table 1 (e.g. a digital camera, a digital camcorder, a digital audio player and a portable DVD player, this will surely occur in a few years!), his overall storage expenses could be very high (>$500).

TABLE 1
Storage costs of several popular multimedia devices

| | Typical | Storage | Storage | |
|---|---|---|---|---|
| | Usage | Need | Cost* | Storage Types |
| Digital Still | ˜200 | ˜0.5 GByte | ˜$100 | Removable Flash |
| Camera | photos | | | card (CF, MM, SD, |
| | | | | MS, xD . . . ) |
| Digital Audio | ˜200 | ˜1 GByte | ˜$150 | Microdrive |
| Player | songs | | ˜$200 | Embedded Flash |
| Digital | ˜2 hours | ˜4 GByte | ˜$100 | Videotape |
| Camcorder | video | | | (VHS, 8 mm, Hi8, |
| | | | | MiniDV, μMV . . . ) |
| | | | ˜$300 | DVD-R |
| Portable | ˜10 | ˜30 GByte | ˜$150 | DVD |
| DVD player | movies | | | |

| | | |
|---|---|---|
| GPS, Portable Game, PDA, | ??? | ??? |
| PVR, Cell phone . . . | | |

*including media cost and drive cost

Besides a high overall storage cost (>$500), the existing multimedia storages have poor to at most mediocre performance (except for Microdrive in Table 1). For example, the fastest flash now can only reach ˜5 MB/s write speed, far slower than any HDD. This is why digital still camera cannot take many pictures at a time (which is known as limited exposure depth). Videotape is even worse. It only allows serial access, which makes video post-processing extremely inconvenient. In addition, because it is dedicated to a single type of multimedia application and has limited capacity (under a reasonable price), the existing storage is not scalable, i.e. the number of multimedia applications associated with a storage cannot be easily scaled up.

Accordingly, the present invention discloses a smart hard-disk drive (sHDD). It can store data for and diretly (i.e. without using a computer as an intermediary) communicate with at least two types of multimedia devices. With a large capacity (for 1.8″, 40 GB now, 100 GB in 2-3 years!), small size (of a thick credit-card) and reasonable price (˜$150), sHDD will be an ideal universal multimedia storage platform. In addition, sHDD is more convenient to users and has the best performance. Furthermore, sHDD is scalable, i.e. it can readily support newly designed multimedia devices.

### OBJECTS AND ADVANTAGES

It is a principle object of the present invention to provide a universal multimedia storage platform which supports direct communication with multiple multimedia devices—smart hard-disk drive (sHDD);

It is a further object of the present invention to provide an sHDD which supports direct download from a digital recording device;

It is a further object of the present invention to provide an sHDD which supports direct upload to a digital playing device;

It is a further object of the present invention to provide an sHDD that supports direct communication with multimedia devices through a shared interface.

In accordance with these and other objects of the present invention, a smart hard-disk drive (sHDD) is disclosed in the present invention.

### SUMMARY OF THE INVENTION

The present invention discloses a smart hard-disk drive (sHDD). It can store data for and directly (i.e. without using a computer as an intermediary) communicate with at least two types of multimedia devices (e.g. direct download from a digital recording device and/or direct upload to a digital playing device). It can also directly communicate with a computer.

Recently, the storage capacity of portable hard-disk drive (HDD) (i.e. small form-factor HDD, e.g. 2.5″, 1.8″ HDD) increases tremendously: for 2.5″ HDD, 80 GB; for 1.8″ HDD, 40 GB (this will reach 100 GB in 2-3 years!). If it is used for only a single multimedia application, this huge capacity will be wasted (like in an ipod). Only when it can be shared by a large number of multimedia applications, will the HDD capacity be efficiently used. Accordingly, for HDD, the “bundled” storage model is no longer valid; instead, a “decoupled” model—the portable storage (i.e. HDD) is decoupled from its associated portable multimedia devices—is more appropriate. According to this “decoupled” model sHDD is preferably used as a shared storage for multiple multimedia applications, i.e. realization of universal multimedia storage platform.

It cannot be stressed enough that, if sHDD is used as storage for just one type of multimedia device, it does not offer much cost advantage (˜$150 for sHDD vs. each storage costs listed in Table 1); However, when the number of multimedia devices owned by a consumer grows (e.g. he owns all devices listed in Table 1, which will surely occur in a few years!), sHDD will offer significant savings on the overall storage costs (˜$150 for sHDD vs. >$500 if all multimedia devices use the existing storages).

The existing USB-based portable HDD cannot directly communicate with any existing multimedia device. It needs to use a computer as an intermediary. The computer is bulky and heavy. To be truly portable, sHDD should support direct communication with existing multimedia devices, i.e. without using a computer as an intermediary. With the advent of USB host and USB on-the-go (OTG) technologies, direct communication between sHDD and multimedia devices becomes possible. An sHDD supports direct data download from a digital playing devices and/or direct data upload to a digital playing device.

As a shared storage, sHDD needs to communicate with a large number of multimedia devices. It is impractical to build on the sHDD a large number of interfaces (e.g. a separate interface for each device type). To simplify the sHDD design, preferably only a limited number of interfaces are built on the sHDD; and these interfaces are shared by multimedia devices as the common communication gateway to the sHDD. Fortunately, this shared interface does exist in digital era. USB is the most popular shared interface. It is the common gateway between a computer and multimedia devices. According to the present invention, USB can be used as the common interface shared by multimedia devices to communicate with the sHDD.

Because its core is HDD, sHDD has the best performance. It has the fastest read/write speed and offers random access. Moreover, sHDD is more convenient to users. It can greatly simplify the data transfer process. In prior arts, the storage in multimedia devices is, in fact, an intermediate storage; the final information destination (or original information source) is an HDD in a computer (e.g. even though a traditional camera user saves the captured photos in the CF card on-the-go, he will eventually copy these photos to an HDD.) In contrast, for the sHDD, data can be directly transferred to/from the device, bypassing any intermediate storage (suppose that the multimedia device is large enough to hold the sHDD and therefore supports real-time data transfer.)

Compared with existing storage, sHDD is scalable, i.e. the number of multimedia applications supported by the sHDD can be easily scaled up. Moreover, the “decoupled” storage model (i.e. storage and device are decoupled into two separate entities) can further simplify the design of new multimedia devices: for manufacturers, they do not have to include storage in the new device design, but just need to include the interface block; for consumers, they do not have to pay extra for storage. Accordingly, the newly designed devices will cost less and be more easily accepted by market.

### BRIEF DESCRIPTION OF THE DRAWINGS

FIG. 1 illustrates a prior-art USB-HDD and its usage model with multimedia devices;

FIGS. 2A-2D illustrates several preferred usage models of a smart hard-disk drive (sHDD): FIG. 2A is its preferred usage model with a digital recording device; FIG. 2B is its preferred usage model with another digital recording device; FIG. 2C is its preferred usage model with a digital audio player; FIG. 2D is its preferred usage model with a computer;

FIG. 3A illustrates an sHDD as universal multimedia storage platform; FIG. 3B illustrates a preferred directory structure in the sHDD; FIG. 3C illustrates a preferred playlist-tree structure in the “music” directory;

FIG. 4A is an external view of a first preferred sHDD; FIG. 4B is an external view of a second preferred sHDD;

FIG. 5A is a cross-sectional view of the first preferred sHDD in the xy plane; FIG. 5B is a cross-sectional view of the first preferred sHDD in the yz plane;

FIG. 6A is a preferred circuit block diagram of a preferred sHDD; FIG. 6B is a preferred motherboard layout of a preferred sHDD;

FIG. 7 illustrates a preferred sHDD whose driver files are stored at the head-disk assembly;

FIG. 8A illustrates a preferred sHDD with download means; FIG. 8B illustrates a preferred data structure during the download process; FIG. 8C illustrates a preferred download process from a digital recording device to an sHDD;

FIG. 9A illustrates a preferred sHDD with upload means; FIG. 9B illustrates a preferred data structure during the upload process; FIG. 9C illustrates a preferred upload process from an sHDD to a digital playing device;

FIG. 10A illustrates a preferred digital playing device with playlist-selection means; FIG. 10B illustrates a preferred data structure on the digital playing device and the sHDD during the playlist selection process; FIG. 1C illustrates a preferred playlist selection process.

### DETAILED DESCRIPTION OF THE PREFERRED EMBODIMENT

FIG. 1 illustrates a prior-art USB-HDD 4 and its usage model with multimedia devices 6. This USB-HDD 4 is a portable HDD with an USB interface. At the first glance, the USB-HDD 4 seems to be a good candidate for the multimedia storage. Unfortunately, it is a “dumb” (or passive) device: it cannot directly communicate with existing multimedia devices 6 (e.g. a digital still camera 38, a digital audio player 48), but needs to use a host computer 2 to act as an intermediary. Even a notebook computer 2 would be heavy (weight >6 lb, including casing and power) and bulky (briefcase-sized). Accordingly, the prior-art USB-HDD does not offer true portability.

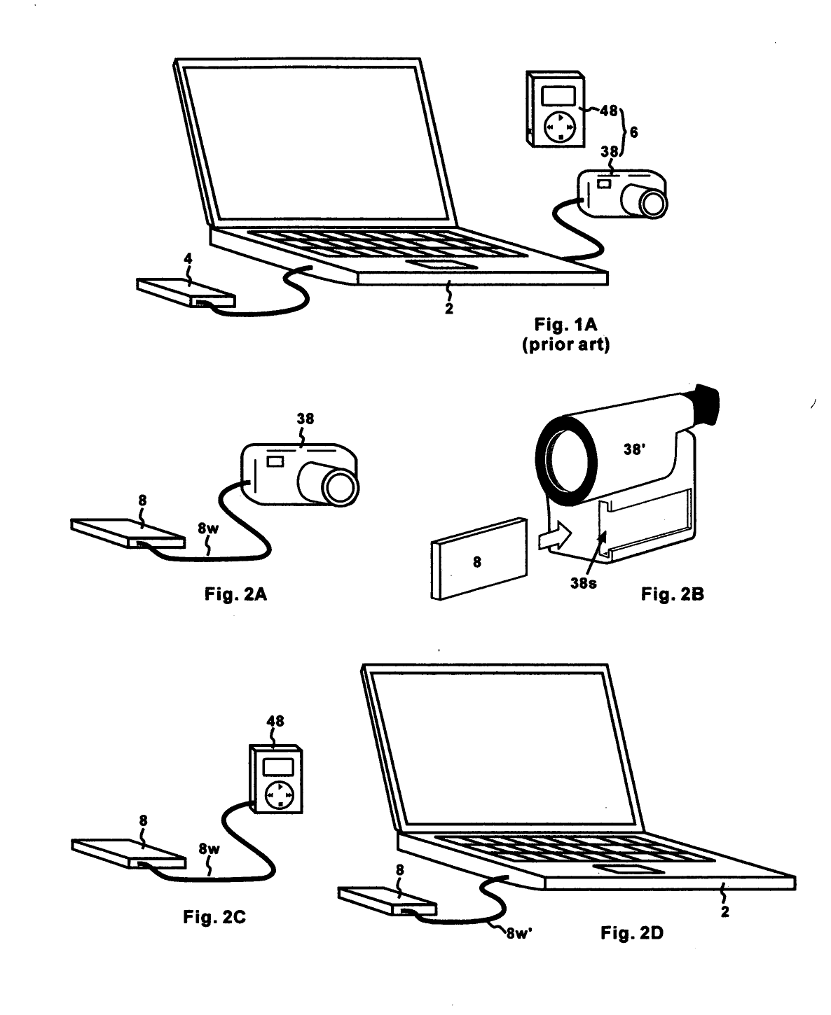

To overcome the difficulties faced by USB-HDD and other existing storages, the present invention discloses a smart hard-disk drive (sHDD). An sHDD can store data for and directly (i.e. without using a computer as an intermediary) communicate with at least two types of multimedia devices. For example, it can directly download data from a digital recording device 38, upload data to a digital playing device 48, as well as directly communicate with a computer 2, preferably all through an USB interface. FIGS. 2A-2D illustrates several preferred usage models.

FIG. 2A illustrates a preferred usage model of an sHDD 8 with a digital recording device—digital still camera 38. During a photo session, when the removable flash card inside the camera 38 is full, the user connects the sHDD 8 to the camera with an USB cable 8w, and then transfers all photos on the removable flash card to the sHDD 8. As a result, photos on the flash card can be erased and the flash card can re-used.

FIG. 2B illustrates a preferred usage model of an sHDD 8 with another digital recording device—digital camcorder 38′. This usage model allows real-time data transfer. A camcorder 38′ is typically large and a holding structure (e.g. a slot) 38s can be designed therein. During a video session, an sHDD 8 can be inserted into the holding structure 38s. Videos can be downloaded into the sHDD 8 real-time, thus eliminating the need for any videotape or DVD-R (and their drives).

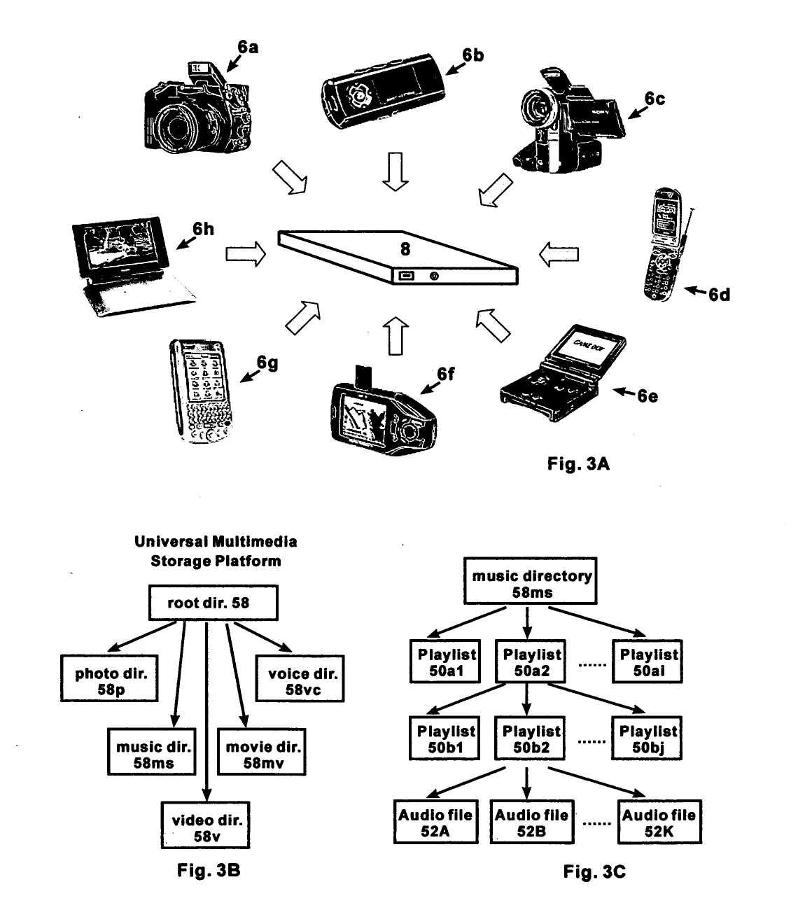

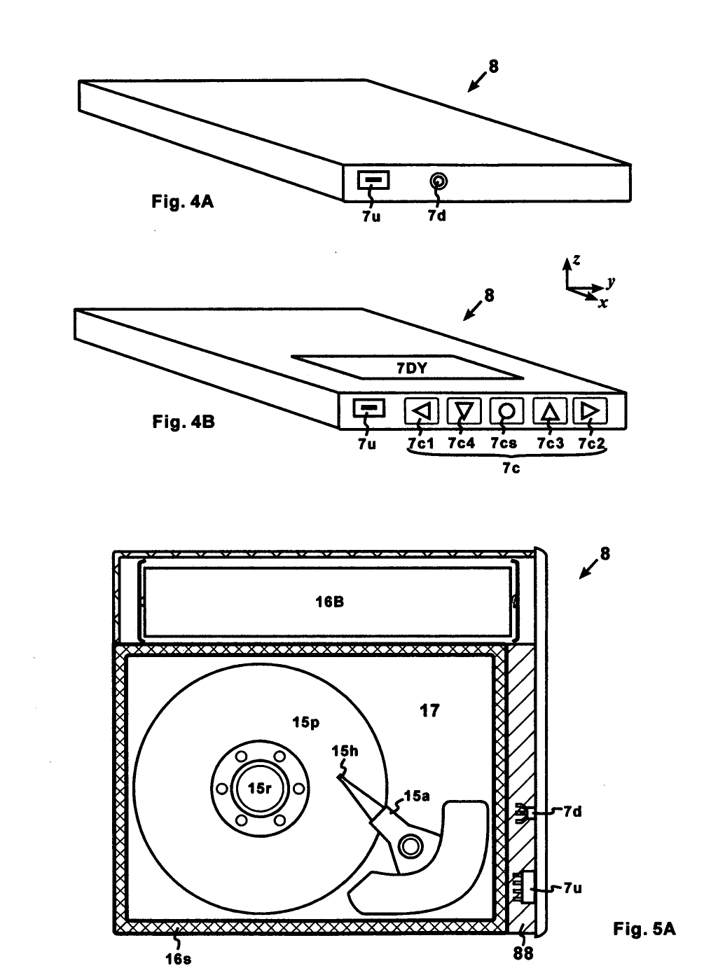

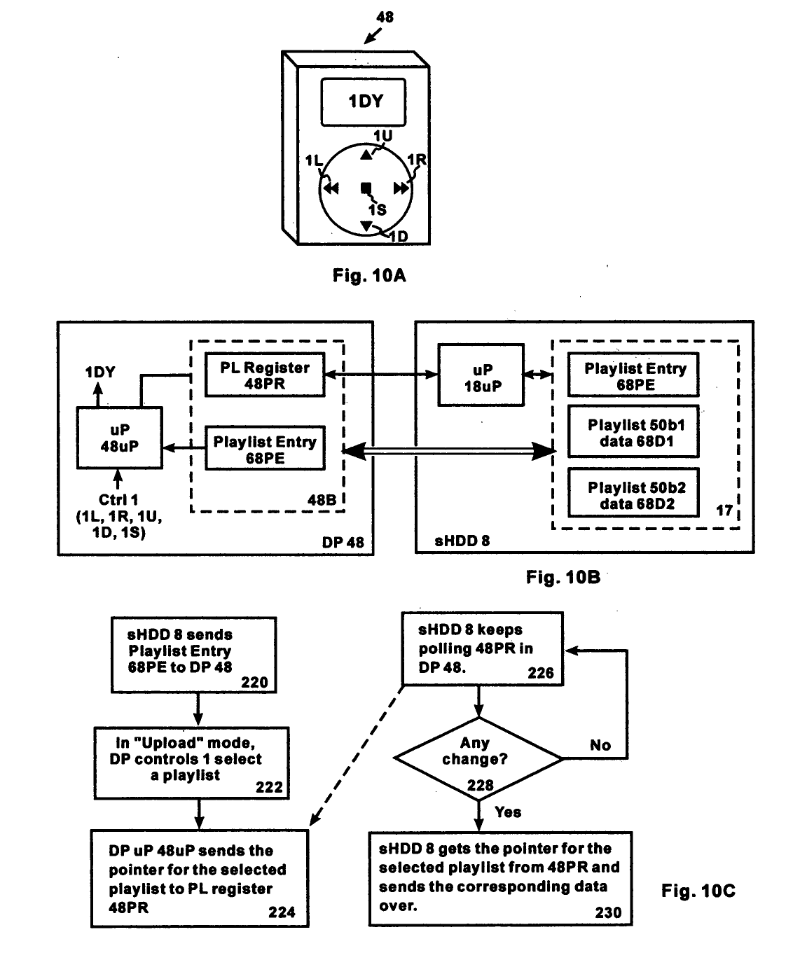

sHDD is particularly useful for digital playing devices. Because a user wants to carry a large collection of music, movies, and game titles on-the-go, the storage demands from these devices are extremely strong. FIG. 2C illustrates a preferred usage model of an sHDD 8 with a digital playing device (e.g. a digital audio player) 48. When a user wants to select a playlist (which comprises a group of files to be played, e.g. a set of music audio files, referring to FIG. 3C) from the sHDD 8, he connects the sHDD 8 to the device 48 with an USB cable 8w, makes the selection by using the selection means on the sHDD 8 (referring to FIG. 4B) or on the digital audio player 48 (referring to FIGS. 10A-10C), then transfers the selected files from the sHDD 8 to the device 48. Apparently, this usage model is also applicable to digital movie players and other digital playing devices.

FIG. 2D illustrates a preferred usage model of an sHDD 8 with a computer 2. The sHDD 8 is, in fact, a stripped-down computer with primarily storage function and minimum processing power. A computer 2 has more processing power and better connectivity. When a user comes home, he can connect an sHDD 8 with a computer 2 and use the computer 2 to process the information stored on sHDD 8. For example, he can organize files/directories on sHDD, edit playlist or video on sHDD, print photos from sHDD, or copy files from the web (or, computer's HDD, DVD) to sHDD.

As is illustrated in FIG. 3A, sHDD 8 is an ideal universal multimedia storage platform. Besides digital still camera 6a and digital audio player 6b, it can store data for and directly communicate with a large number of multimedia devices, e.g. digital camcorder 6c, cell phone 6d, portable game machine 6e, global positioning system (GPS) 6f, personal digital assistant (PDA) 6g, portable movie player 6h, personal versatile recorder (PVR). With a large storage capacity (for 1.8″ sHDD, 40 GB now, 100 GB in 2-3 years!), sHDD can satisfy all on-the-go storage needs from a typical consumer.

Referring now to FIG. 3B, a preferred directory structure in an sHDD is illustrated. Preferably, files from different device types are stored in different directories under the root directory 58. For example, when a new set of digital photos are downloaded from a digital still camera 6a to the sHDD 8, they are stored under the “photo” directory 58p in an automatically created sub-directory. Other directories under the root 58 include “music” directory 58 ms, “video” directory 58v, “movie” directory 58mv, and “voice” directory 58vc, etc.

Because of the large music collection a user might own, music audio files are preferably organized into a hierarchical structure—playlist-tree structure. As is illustrated in FIG. 3C, under the “music” directory 58 ms, there are a plurality of first-level playlists 50a1, 5a2, . . . 50ai. Each first-level playlist (e.g. 50a2) comprises a plurality of lower-level playlists 50b1, 50b2, . . . 50bj. The lowest-level playlist (e.g. 50b2) comprises a plurality of audio files 52A, 52B, . . . 52K. Music data are preferably uploaded from the sHDD 8 to the digital audio player 6b in the unit of playlist. Apparently, other pre-recorded contents, such as movies, game titles, can also be organized into playlist-tree structures.

FIG. 4A is an external view of a first preferred sHDD. For 1.8″ sHDD, its size is ˜80×60×1 mm³. It has about the same footprint as credit cards and can be placed into a wallet. With a storage capacity of 40 GB now (100 GB in 2-3 years!), sHDD is adequate as a shared storage for most on-the-go multimedia applications. It further comprises an USB interface 7u and a display 7d. The USB interface 7u can be used as a shared interface, through which various multimedia devices 6, as well as a computer 2, can communicate with the sHDD 8. Besides USB, other interfaces such as IEEE 1394, Ethernet and even wireless interfaces (referring to Provisional Application Sr. No. 60/585,123) may also be used. The display 7d indicates the status of the sHDD 8, e.g. running or sleeping, battery full or empty. Note that this preferred embodiment does not comprise any selection means (e.g. control inputs and alphanumeric screen). When it is used in combination with a digital playing device, the selection means on the device will be used to make selection (referring to FIGS. 10A-10C).

FIG. 4B is an external view of a second preferred sHDD. This preferred sHDD comprises selection means, e.g. control inputs 7c1, 7c2, 7c3, 7c4, 7cs represents “Previous Playlist”, “Next Playlist”, “One Playlist Level Up”, “One Playlist Level Down”, “Select”, respectively. Control inputs 7c1-7c4 and alphanumeric screen 7DY can be used to browse through the playlist-tree structure of FIG. 3C; and control input 7cs can be used to select the playlist to be uploaded to the digital playing device.

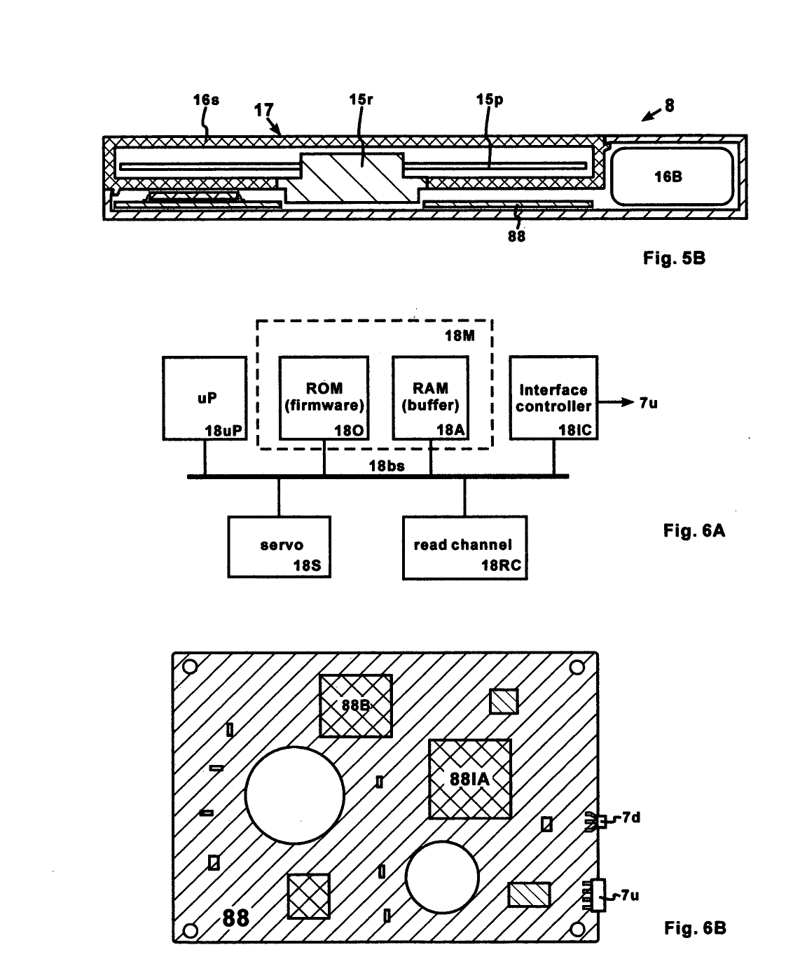

FIGS. 5A-5B are cross-sectional views of the sHDD in xy and yz planes. It comprises a shell 16s, a motherboard 88, a battery 16B, and a head-disk assembly (HDA) 17. The motherboard 88 houses the circuitry for the sHDD 8 (referring to FIG. 6B). The battery 16B provides power to the sHDD 8. If the sHDD 8 can draw power from the multimedia devices it is connected to, batter 16B may not be needed. The HDA 17 is the physical storage location of the sHDD 8. To those skilled in the art, it comprises at least a platter 15p, a rotor 15r, at least a head 15h and an arm 15a.

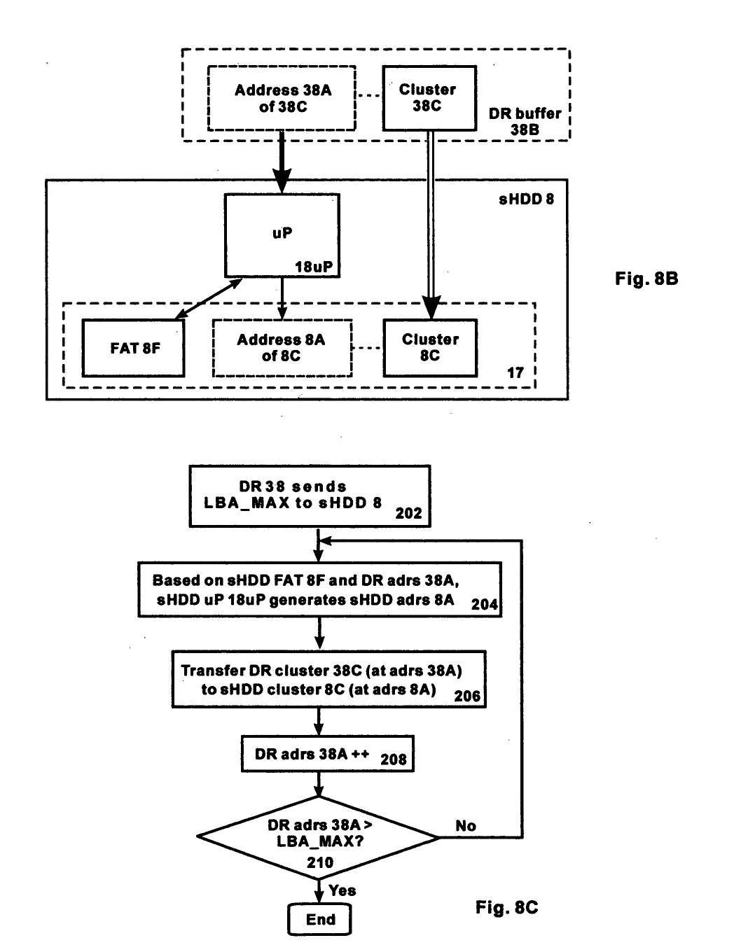

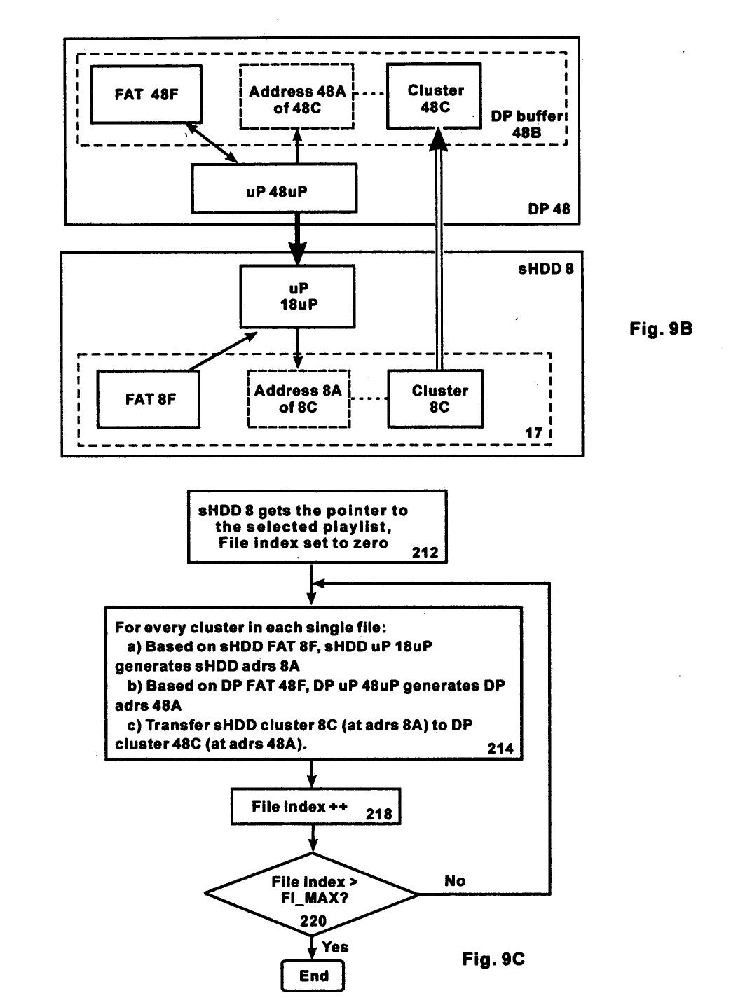

FIG. 6A is a preferred circuit block diagram of a preferred sHDD. It comprises system blocks (e.g. a processing (uP) block 18uP, a memory block 18M and an interface controller block 181C), and HDD blocks (e.g. a servo block 18S and a read channel block 18RC). They communicate through a system bus 18bs. The uP 18uP provides sHDD 8 with “intelligence”, e.g. managing the disk data (referring to FIGS. 8A-9C). The system memory block 18M comprises ROM and RAM blocks 180, 18A: the ROM block 180 stores firmware for the sHDD 8; the RAM block 18A acts as the sHDD buffer. The interface controller block 181C preferably can perform USB host/device or on-the-go (OTG) functions. It comprises USB host/device (or OTG) controller, e.g. AT43USB380 from Atmel, ISP1362 from Phillips, or SL811HST from Cypress. To those skilled in the art, the servo block 18S and read channel block 18RC control low-level HDD operations.

Typically, the power consumption of HDD (P_{HDD}) is large. For multimedia applications, the rate of which data are generated or consumed (R_{MD}˜1 MB/s) is far less than the data-transfer speed of the HDD (R_{HDD}˜100 MB/s). Accordingly, “intermittent access” can be utilized to reduce the power consumption, i.e. during most time of the sHDD's operation, the HDA is not runing and multimedia devices only read/write data from the sHDD buffer 18A; only when the data in the buffer 18A is almost full or used up, the HDA is turned on and accessed. From an energy-saving perspective, each time when a data block with the size of the sHDD buffer 18A S_{buffer} is accessed, it is required that

Energy consumption without buffer (E_{w/o buffer})>Energy consumption with buffer (E_{w/buffer}) Because,

E_{w/o buffer}=P_{HDD}*S_{suffer}/R_{MD}

E_{w/buffer}=E_{HDD start}+P_{HDD}*S_{w/buffer}/R_{HDD}

(E_{HDD start} is the energy consumption to turn on the HDA,) the sHDD buffer size (S_{buffer}) needs to satisfy the following condition:

S_{buffer}>E_{HDD start}/P_{HDD}/(1/R_{MD}−1/R_{HDD}).

FIG. 6B is a preferred motherboard layout of said preferred sHDD. In order to simplify the design and lower the overall system cost, this motherboard design follows an “HDD integration” approach (also referring to patent application Ser. No. 10/685,887)—instead of using at last two printed-circuit boards (one for the HDD circuitry, the other for the system circuitry), at least a portion of the HDD circuitry (read channel, servo, etc.) and at least a portion of the system circuitry (uP, memory, interface controller, etc.) are built on the same motherboard 88. In this preferred embodiment, the motherboard 88 comprises an integrated disk controller chip 88IA, a buffer chip 88B, and other IC chips. Similar in-design to 88i5540 from Marvell and CL-SH8665 from Cirrus Logic, the integrated disk controller chip 68IA comprises: read channel block 18RC, servo block 18S, interface controller block 18IC, and uP block 18uP. In prior-art, the HDD data need to be converted to the IDE format before sending to the system circuitry. However, according to “HDD integration”, the HDD data can directly communicate with system circuitry in ant format (not necessarily IDE). This can speed up the data transfer rate. Moreover, the HDD circuitry can share the system resources (e.g. uP, ROM and RAM) on the motherboard 88. This can further lower the overall system cost. Note that the USB connector 7u can also be used to charge the battery 16B.

To perform the desired data-transfer functions, besides hardware, sHDD needs to be equipped with necessary software. Among these, the most important ones are the drivers for various supported devices, which control the data transfer between the device and sHDD. One way to store these drivers is to follow the traditional embedded-system design approach: bun these drivers into the system ROM. Because the number of supported devices could be quite large, a large system ROM 18O is required. In addition, whenever a new device type needs to be supported, a firmware upgrade is needed. This is expensive and inconvenient.

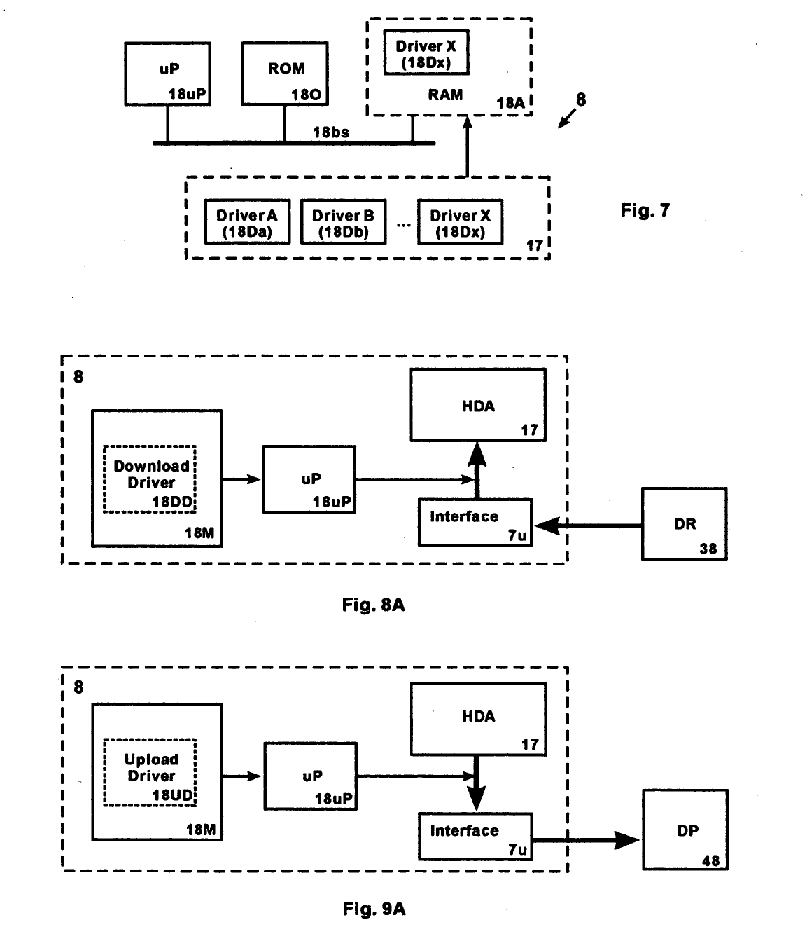

To address these issues, the present invention proposes to store drivers (18Da, 18Db . . . 18Dx) in HDA 17 (FIG. 7). With a large capacity, HDA 17 is a natural place to store drivers. After a device 6 is connected to an sHDD 8, its device type is recognized by enumeration. Then the driver 18Dx associated with this device type is uploaded from the HDA 17 to RAM 18A. Accordingly, ROM 180 only needs to store the bootstrap code, which can be quite small and embedded in the system uP 18uP. Using this approach (i.e. store driver 18Dx in the HDA 17 and upload it when needed), the sHDD 8 can support any type of devices and the overall system cost will be low.

FIG. 8A illustrates a preferred sHDD 8 with download means. It comprises a processing block 18uP, a memory block 18M comprising a download driver 18DD, an interface block 7u, and HDA 17. When a digital recording device (DR) 38 is connected with the sHDD 8, it is first recognized as a source device (i.e. a device which wants to copy its data to the sHDD). Then an appropriate download driver 18DD is selected (or loaded). Under the control of 18DD, data are downloaded from the device 38 to sHDD 8.

FIG. 8B illustrates a preferred data structure during a download process from a DR 38 to an sHDD 8. DR buffer 38B (referring to FIG. 7C of Provisional Application Sr. No. 60/585,123) comprises a plurality of data clusters 38C with corresponding addresses 38A. Similarly, HDA 17 contains a plurality of data clusters 8C with corresponding addresses 8A. HDA 17 further comprises a file with data distribution information, e.g. sHDD FAT 8F. It contains the cluster location information for each file.

The download process from the DR to sHDD is relatively simple. It may utilize a “carpet transfer” method—all information recorded by the DR is transferred to the sHDD “blindly”, i.e. a large number of clusters located continuously in the storage space (either at the logic or physical level) are transferred “indiscriminately” to the sHDD 8. FIG. 8C illustrates its detailed steps:

A) DR 38 sends the uppermost DR address LBA_MAX of the cluster that contains valid data to the sHDD 8 (step 202);

B) From address 0 to LBA MAX (steps 208 and 210), for each DR address 38A, sHDD 8 performs the following operations:

1. Based on the sHDD FAT 8F and the DR address 38A, the sHDD uP 18uP generates the sHDD address 8A (step 204);

2. Transfer the DR cluster 38C (at the DR address 38A) to the sHDD cluster 8C (at the sHDD address 8A) (step 206).

FIG. 9A illustrates a preferred sHDD with upload means. Its memory block 18M comprises an upload driver 18UD. When a digital playing device (DP) 48 is connected with the sHDD 8, it is recognized as a target device (i.e. a device which wants to copy data from the sHDD). Then an appropriate upload driver 18UD is selected (or loaded). Under the control of 18UD, data are uploaded from the sHDD 8 to the device 48. It is apparent to those skilled in the art, in order to support both download and upload, sHDD 8 needs to comprise both the download and upload drivers 18DD, 18UD.

FIG. 9B illustrates a preferred data structure during an upload process from an sHDD 8 to a DP 48. DP buffer 48B (referring to FIG. 8C of Provisional Application Sr. No. 60/585,123) comprises a plurality of data clusters 48C with corresponding addresses 48A. DP buffer 48B further comprises a DP FAT 48F. It contains data distribution information in DP buffer 48B. Similarly, HDA 17 comprises an sHDD FAT 8F and a plurality of data clusters 8C with corresponding addresses 8A.

The upload process from the sHDD to DP is more complex than the download process. It may utilize a “selective transfer” method, i.e. only the files associated with the selected playlist are transferred. For “selective transfer”, the data transfer occurs at the file level and comprises the following steps (FIG. 9C):

A) sHDD 8 gets the pointer to the selected playlist and set the file index to 0 (all files in a playlist are indexed by numbers from 0 to FI_MAX; FI_MAX is the file index corresponding to the last file in this playlist) (step 212);

B) From file index 0 to FI_MAX (steps 218, 220), for every cluster in each single file, sHDD performs the following operations:

1. Based on the sHDD FAT 8F, the sHDD uP 18uP generates the sHDD address 8A;

2. Based on the DP FAT 48F, the DP uP 48uP generates the DP address 48A;

3. Transfer the sHDD cluster 8C (at the sHDD address 8A) to the DP cluster 48C (at the DP address 48A) (step 214).

In order to make a playlist selection from vast multimedia collections on the sHDD, at least one of the DP and sHDD need to have a playlist-selection means. In the preferred embodiment of FIG. 4B, this selection means is located at the sHDD 8. This adds to the cost and weight of the sHDD. It is desirable to design a DP with playlist-selection means, i.e. it can select playlist from an sHDD. This removes the sHDD from the burden of building selection means therein (as in the case of the preferred embodiment of FIG. 4A). FIGS. 10A-10C illustrates a preferred embodiment and the associated playlist selection process.

FIG. 10A is an external view of a preferred DP 48 with playlist-selection means. It has two modes: “PLAY” and “SELECT” modes. At the “PLAY” mode, it works same as a conventional DP. For example, control inputs 1L, 1R, 1U, 1D, 1S represent “Previous Song”, “Next Song”, “Volume Up”, “Volume Down”, “Play/Pause”, respectively. Whereas, at the “SELECT” mode, they (1L-1S) represent differently: “Previous Playlist”, “Next Playlist”, “One Playlist Level Up”, “One Playlist Level Down”, “Select”, respectively. Using these buttons, a user can browse through the whole playlist tree (FIG. 3C) and select the desired playlist. To those skilled in the art, a DP with playlist-selection means can use the existing hardware of a conventional DP; only a DP firmware upgrade is needed.

FIGS. 10B-10C illustrate a preferred data structure and playlist-selection process on the DP and sHDD. The HDA 17 contains a playlist entry file 68PE and a number of playlist data files 68D1, 68D2 . . . The playlist entry file 68PE carries the directory information of the playlist tree. The playlist data files (68D1, 68D2 . . . ) contain the music audio files associated with each playlist. When the DP 48 is connected with sHDD 8, the playlist entry file 68PE is first uploaded from the sHDD 8 to DP 48 (at this time, no music audio file is uploaded yet) (step 220). The user browses through the playlist tree and uses control inputs 1 and display 1DY to select the one he prefers (step 222). After a playlist is selected, the pointer to said playlist is saved into a playlist register 48PR. Playlist register 48PR can be located at a fixed location in the DP buffer 48B (step 224). During this time, the sHDD 8 keeps polling the playlist register 48PR (step 226). If there is any change in this register 48PR (step 228), the sHDD 8 will get its content and upload the corresponding files to the DP 48 (step 230, also referring to FIGS. 9B-9C).

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A smart hard-disk drive (sHDD), comprising:
a head-disk assembly for storing data for at least two types of multimedia devices;
communication means for directly transferring data between said head-disk assembly and a selected one of said at least two types of multimedia devices.

2. The sHDD according to claim 1, further comprising:
an interface for connecting said sHDD to any one of said at least two types of multimedia devices;
whereby said sHDD can directly communicate with any one of said at least two types of multimedia devices through said interface.

3. The sHDD according to claim 2, wherein said interface is a serial wired data interface.

4. The sHDD according to claim 3, wherein said serial wired data interface is selected from a group of interfaces consisting of USB, IEEE 1394, and Ethernet.

5. The sHDD according to claim 1, wherein said communication means further comprises an interface controller complying with USB host and/or USB on-the-go protocols.

6. The sHDD according to claim 1, wherein said communication means further comprises:
download means for directly transferring data from a first one of said multimedia devices to said head-disk assembly;
upload means for directly transferring data from said head-disk assembly to a second one of said multimedia devices.

7. The sHDD according to claim 6, wherein:
said download means comprises a download driver for controlling data transfer from said first multimedia device to said head-disk assembly;
said upload means comprises an upload driver for controlling data transfer from said head-disk assembly to said second multimedia device.

8. The sHDD according to claim 7, further comprising a ROM, wherein at least one of said download and upload drivers are stored in said ROM.

9. The sHDD according to claim 7, wherein at least one of said download and upload drivers are stored in said head-disk assembly.

10. The sHDD according to claim 9, further comprising a RAM, wherein a selected one of said download and upload drivers is transferred from said head-disk assembly to said RAM during operation.

11. The sHDD according to claim 1, further comprising a RAM, wherein the size of said RAM is larger than:
(energy consumption to start HDD)/(power consumption of HDD)/[1/(rate of which multimedia data are generated or consumed)−1/(data transfer rate of HDD)].

12. The sHDD according to claim 1, wherein
said disk-head assembly stores at least a disk data-distribution information file and a plurality of data clusters, and
said communication means further comprises a processing block;
whereby said processing block can generate an sHDD address based on said disk data-distribution information file and perform operation on a selected data cluster on said disk-head assembly corresponding to said sHDD address.

13. The sHDD according to claim 12, wherein said disk data-distribution information file is a FAT file.

14. The sHDD according to claim 1, further comprising:
a servo block and a read-channel block for said head-disk assembly;
a motherboard, wherein said servo block, said read-channel block, and at least a portion of the circuitry for said communication means are located on said motherboard.

15. A smart hard-disk drive (sHDD), comprising:
a head-disk assembly for storing data for a digital recording device;
an interface for connecting said sHDD to said digital recording device;
download means for directly transferring data from said digital recording device to said head-disk assembly through said interface.

16. The sHDD according to claim 15, further comprising an download driver for controlling data transfer from said digital recording device to said head-disk assembly.

17. The sHDD according to claim 15, wherein said interface is a serial wired data interface.

18. A smart hard-disk drive (sHDD), comprising:
a head-disk assembly for storing data for a digital playing device;
an interface for connecting said sHDD to said digital playing device;
upload means for directly transferring data from said head-disk assembly to said digital playing device through said interface.

19. The sHDD according to claim 18, further comprising an upload driver for controlling data transfer from said head-disk assembly to said digital playing device.

20. The sHDD according to claim 18, wherein said interface is a serial wired data interface.
